(19) United States
(12) Patent Application Publication
(10) Pub. No.: US 2014/0084553 A1
(43) Pub. Date: Mar. 27, 2014

(54) COLLAPSIBLE MOTORIZED STAIR CHAIR

(71) Applicant: Enrico Carletti, Pieve di Cento (IT)

(72) Inventor: Enrico Carletti, Pieve di Cento (IT)

(73) Assignee: FERNO-WASHINGTON, INC., Wilmington, OH (US)

(21) Appl. No.: 14/117,080

(22) PCT Filed: May 12, 2011
(86) PCT No.: PCT/US2011/036230

§ 371 Date: Dec. 17, 2013

(51) Int. Cl. A61G 5/06

(52) U.S. Cl. CPC A61G 5/061; A61G 5/066
USPC 280/5.22

(57) ABSTRACT

A motorized stair chair for transporting a human subject having a chair frame having front and rear sections; a collapsible seating assembly attached to the front section of the chair frame; ground-contacting wheels coupled to the chair frame; a motor coupled to the chair frame; a removable battery configured to power the motor and the motorized stair chair, wherein the battery and the motor are separately coupled at different locations on the chair frame; and a pair of motorized continuous, rotatable tracks frame; responsive to the motor, the tracks being integrally and pivotally coupled to the rear section of the chair frame, wherein the motorized tracks are configured to engage stairs.

The present application generally relates to medical transport devices. The present application more particularly relates to collapsible motorized stair chairs.

In one embodiment, a motorized stair chair for transporting a human subject is disclosed. The chair includes a chair frame comprising front and rear sections, a collapsible seating assembly attached to the front section of the chair frame, ground-contacting wheels coupled to the chair frame, a motor coupled to the chair frame, a removable battery configured to power the motor and the motorized stair chair, wherein the battery and the motor are separately coupled at different locations to the chair frame, and a pair of motorized continuous, rotatable tracks responsive to the motor, the tracks being integrally and pivotally coupled to the rear section of the chair frame, wherein the motorized tracks are configured to engage stairs.

The motorized stair chair may include a plurality of gears disposed between the motor and the motorized tracks, wherein the motor is configured to drive the motorized tracks via the gears disposed therebetween. The motor and the gear box may be disposed in a housing coupled to the chair frame. The battery may be disposed horizontally or vertically on the rear section of the chair frame. The pair of motorized tracks may further include toothed belts for engaging stairs. The motorized stair chair may also include a track release mechanism configured to release the pair of motorized tracks from an upright position.

The motorized stair chair may also include a controller coupled to the chair frame. The controller may further be operable to pivot the pair of motorized tracks from a raised position to lowered position. The controller may also be operable to drive the pair of motorized tracks in a forward direction or a backward direction. The controller may also be configured to collapse or extend the collapsible seating assembly. The controller may also include a microprocessor. The controller may also provide information to the electronic display. The electronic display may be configured to provide information about the operational state of the battery. The electronic display may further include buttons, switches, toggle switches, a touch screen console, or combinations thereof. The stair chair may also include a plurality of handles coupled to the chair frame, wherein the handles are pivotable, telescoping or combinations thereof.

The chair frame may also include left and right support members, a cross member supported by and positioned between the left and right support members, a pair of hand grips releasably positionable in folded and unfolded positions, and a height adjustable handle bar slidably accommodated in respective cavities of said left and right support members. The stair chair may further include a collapsible seating assembly that includes a seat, a pair of legs pivotally connected to the seat, and wheels rotatably and pivotably mounted to said legs to support the stair chair for movement over the ground surface when said seat assembly is in said open position which permits the person to sit upon said seat.

The pair of motorized tracks may comprise a motorized track assembly. The pair of motorized tracks may also comprise a latching assembly.

These and other advantages and features of the invention disclosed herein, will be made more apparent from the description, drawings and claims that follow.

The present disclosure will become more fully understood from the following detailed description, taken in conjunction with the accompanying figures, wherein like reference numerals refer to like elements, in which:

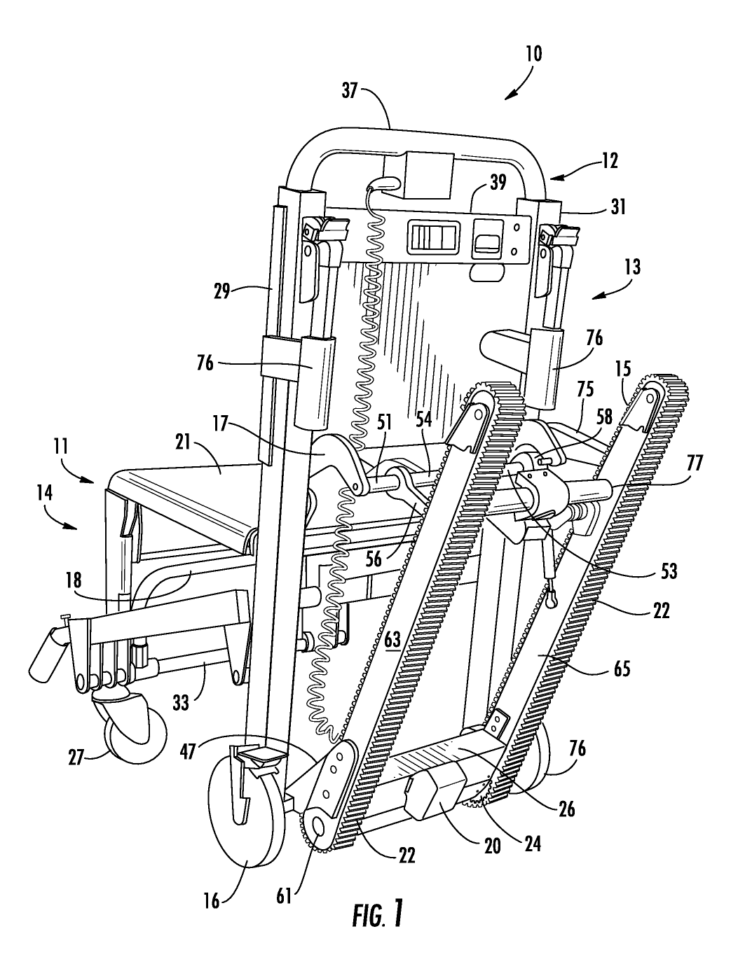

FIG. 1 is a perspective view depicting a rear section of a motorized stair chair in an extended position with a released pair of motorized tracks;

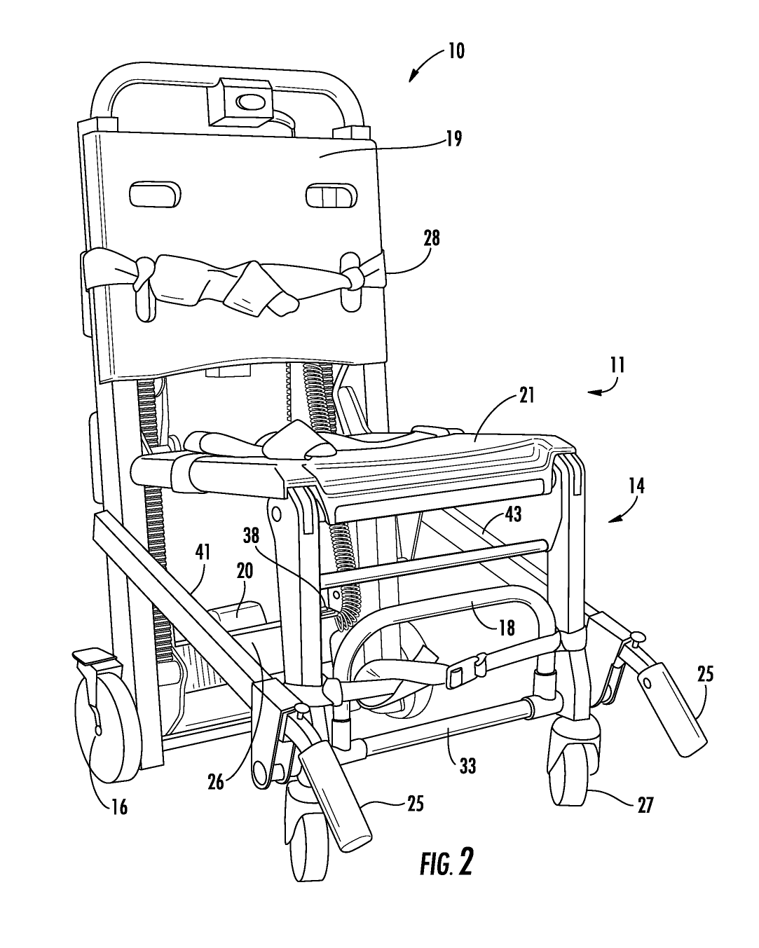

FIG. 2 is a perspective view depicting a front section of the motorized stair chair in an extended position with the pair of collapsed motorized tracks;

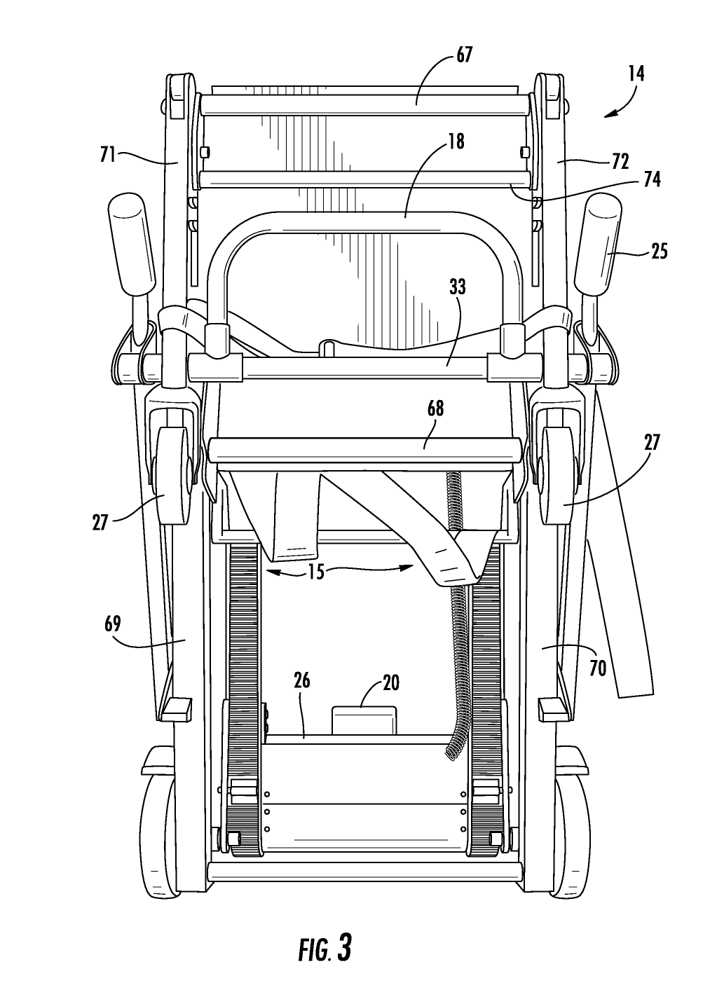

FIG. 3 is side view depicting the rear section of the motorized stair chair in an upright position;

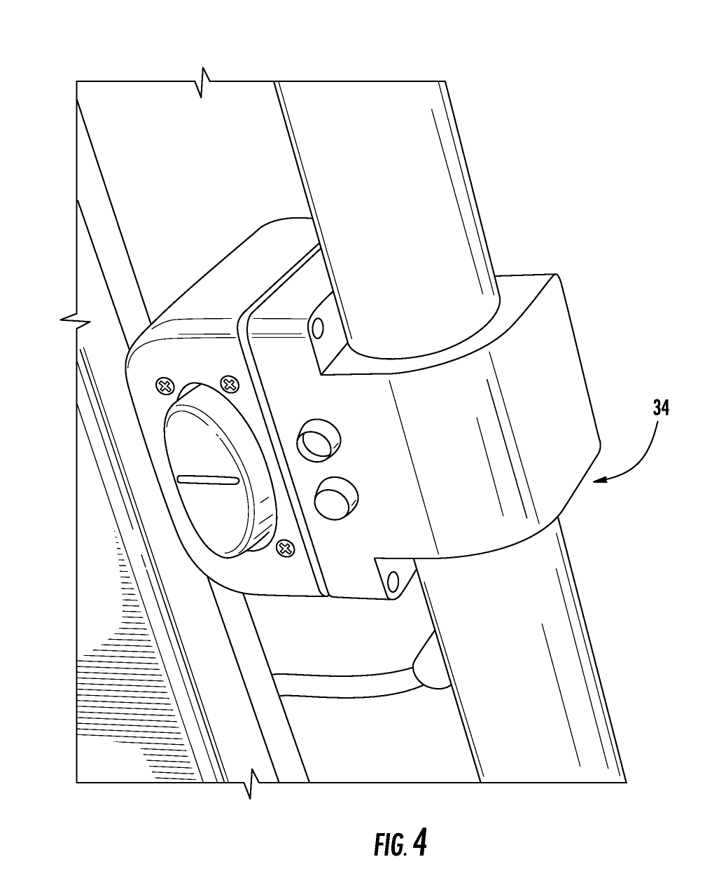

FIG. 4 is a close-up perspective view of a controller attached to the motorized stair chair;

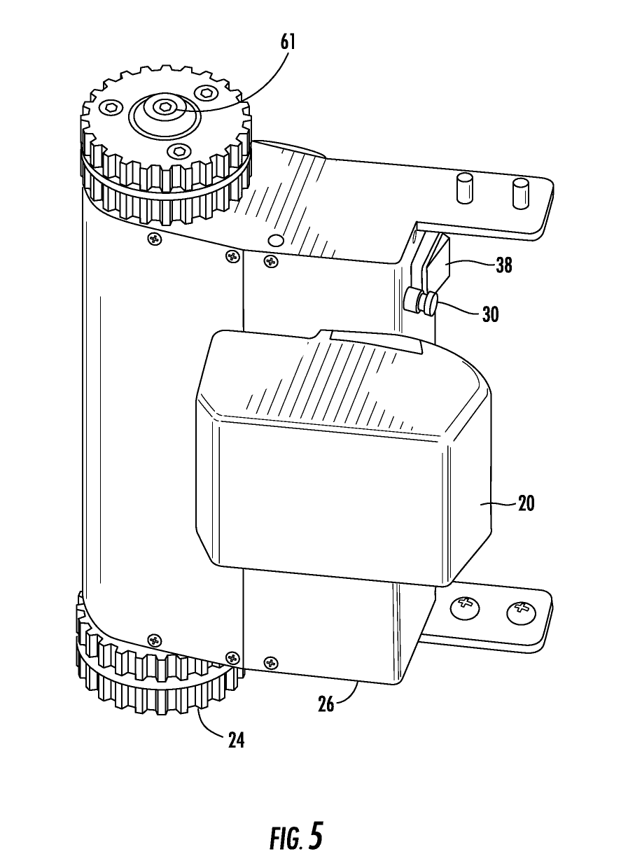

FIG. 5 shows a front view of a removable battery mounted to a motor housing;

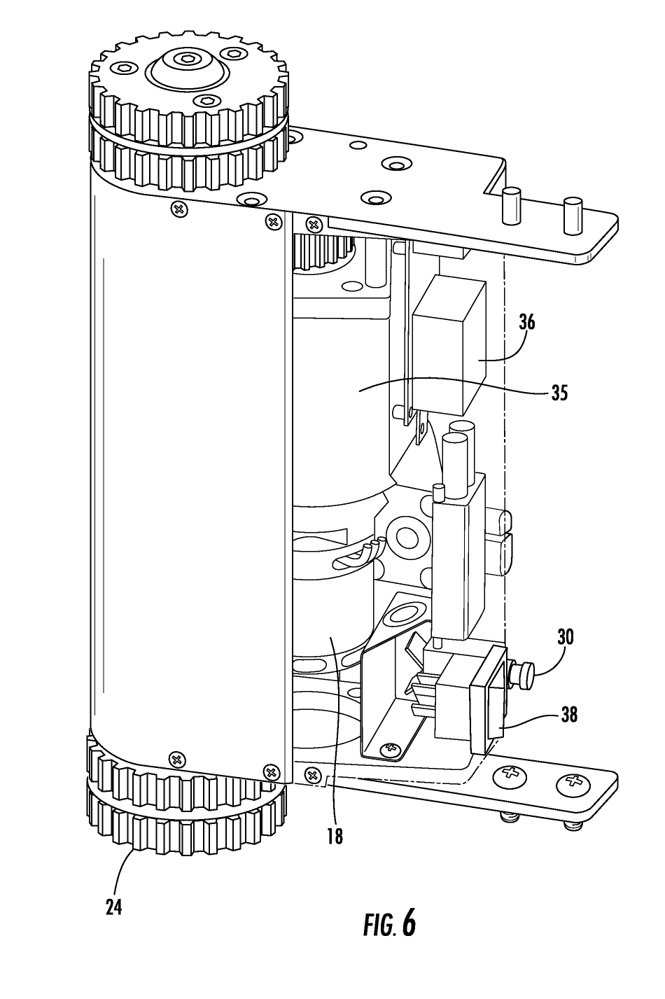

FIG. 6 is a cut-away view of internal components of the motor housing of FIG. 5;

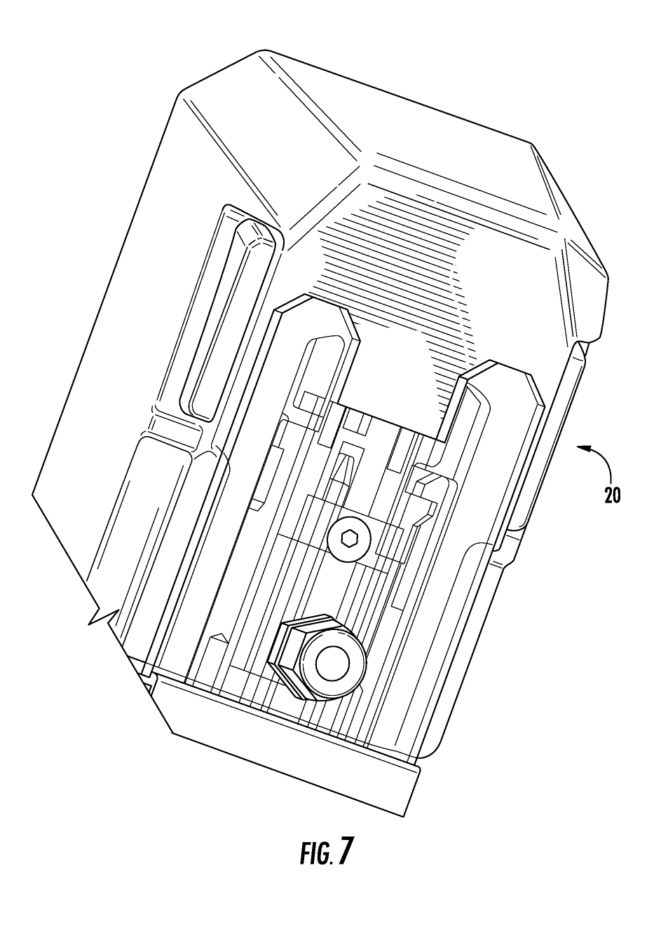

FIG. 7 is a cut-away view of the battery for attachment to the motor housing;

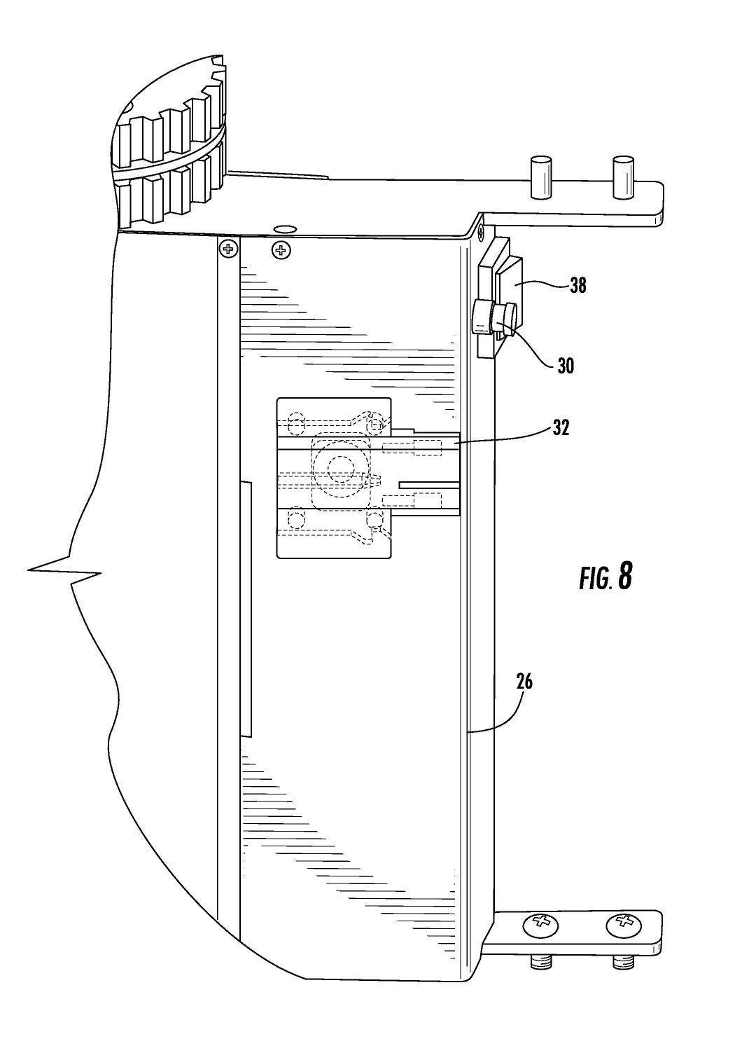

FIG. 8 is a cut-away view of the attachment point for the battery; and

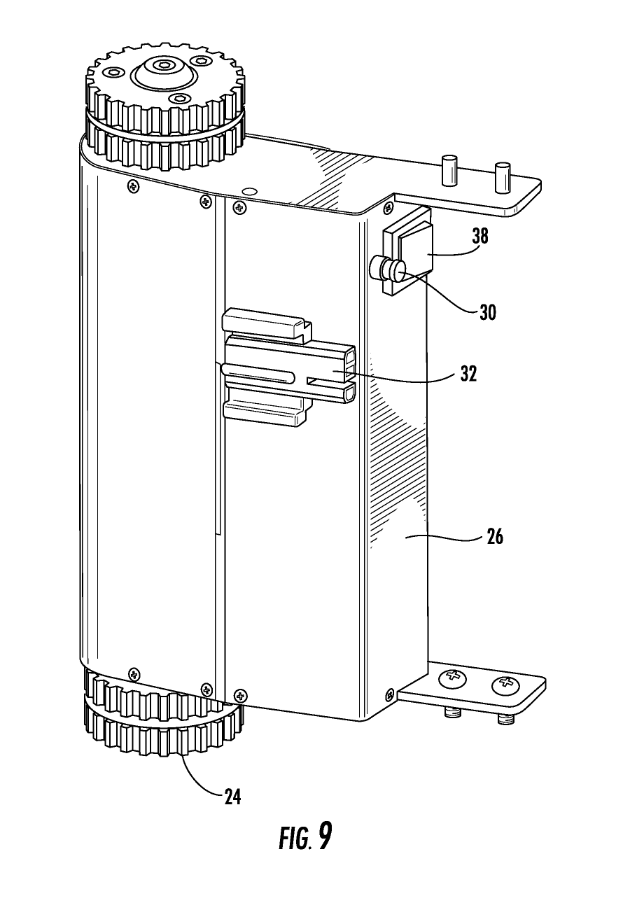

FIG. 9 shows the attachment point for the battery on the motor housing.

Before turning to the figures, which illustrate several embodiments in detail, it should be understood that the application is not limited to the details or methodology set forth in the description or illustrated in the figures. It should also be understood that the terminology is for the purpose of description only and should not be regarded as limiting.

Referring now to FIG. 1, the motorized stair chair 10 with a released pair of motorized tracks is shown, according to an embodiment. The motorized stair chair 10 may include a chair frame 12, a collapsible seating assembly 14, and ground-contacting wheels 16. The chair frame 12 comprises a front section 11 and a rear section 13. The pair of motorized tracks may also comprise a motorized track assembly 15 and a latching assembly 17.

The motorized track assembly 15 is also pivotally mounted to the chair frame 12. The motorized track assembly 15 provides support for movement up and down stairs. The motorized track assembly 15 is also pivotally connected at lower ends, via a pair of brackets 47, to chair frame 12 of stair chair 10 for pivotal movement between collapsed/folded or closed and extended or open positions. In the collapsed or closed position, shown in FIG. 3, the motorized track assembly 15 extends upward from a lower portion of chair frame 12, generally parallel thereto; and in the unfolded or open position, shown in FIGS. 1 and 2, the motorized track assembly 15 extends upward and away from the chair frame 12.

The motorized track assembly 15 is also pivotally connected at an upper portion to latching assembly 17. As shown, the latching assembly 17 is pivotally connected to and supported between the chair frame 12 and the motorized track assembly 15. The latching assembly 17 as a released position, as shown in FIG. 2 which releasably holds the motorized track assembly 15 in the closed position, and a released position, shown in FIG. 1 which releasably holds the motorized track assembly 15 in the open position.

The latching assembly 17 is connected pivotally to and supported between the chair frame 12 and the motorized track assembly 15. The latching assembly 17 has a first pair of arms 51, 53 pivotally connected at first ends thereof to the chair frame 12. A crossbar 54 is mounted between the first pair of arms 51 and 53 at second ends thereof. The crossbar 54 supports a second pair of arms 56 and 58. In one embodiment, the second pair of arms 56 and 58 are pivotally connected to the crossbar 54 and the motorized track assembly 15. In another embodiment, the second pair of arms 56 and 58 are statically mounted to the crossbar 54 and pivotally mounted to the motorized track assembly 15, wherein the crossbar 54 is pivotally mounted between the first pair of arms 51 and 53. The first pair of arms 51 and 53 each have a bent portion, which directs the arms 51 and 53 downwards in the extended position as shown in FIG. 1. It is to be appreciated that the physical shape of the first pair of arms 51 and 53, which situates the crossbar 54 and the second pair of arms 56 and 58 in the illustrated extended position, secures the motorized track assembly 15 in the open position. The movement of the footrest 23 toward the handle bar 37 permits an operator to conveniently pivot and lock the motorized track assembly 15 between its closed and open positions depending on the transport by moving the latching assembly 17 between a collapsed position, shown in FIG. 3, and the extended position, shown in FIG. 2, respectively.

The chair frame 12 includes left and right support members 29 and 31, lower cross member 33, upper cross member 39, and a height adjustable, u-shaped handle bar 37. The handle bar 37 is accommodated slidably in respective cavities of the left and right support members 29 and 31, and may be located releasably in one of a variety of positions which provides an operator the best control and leverage advantage when transitioning the stair chair 10 along the stairs or a surface. At lower ends of the right and left support members 29 and 31 are provided ground-contacting wheels 16 mounted rotatably on the chair frame to support the stair chair 10 for movement over the surface.

Left and right support members 29 and 31 of the chair frame 12 are generally parallel to each other and generally define the left and right sides of stair chair 10. Lower cross member 33 is connected to and extends between lower ends of the support members 29 and 31. The upper cross member 39 of the chair frame 12 is connected to and extends between upper ends of the support members 29 and 31. The ground-contacting wheels 16 are connected to bottom ends of the support member 29 and 31 via suitable brackets. With these connections, frame members 29, 31, 33, and 39 form a sturdy rectangular shaped support frame for the stair chair 10.

Referring now to FIG. 2, a front section of the motorized stair chair in an extended position with a pair of collapsed motorized tracks is shown, according to an embodiment. The front section 11 of the motorized stair chair 10 includes a collapsible seating assembly 14. The collapsible seating assembly 14 is provided to form a seat for a human subject. The collapsible seating assembly 14 is attached to the front section 11 of the chair frame. The collapsible seating assembly 14 may be foldable from an extended position to a collapsible position to allow compact storage of the motorized stair chair 10. The elements and components of the stair chair 10 are connected together so that the stair chair can be extended from a collapsible position (shown in FIG. 3) to an extended position (shown in FIG. 2). In the open form, the human subject can be safely and securely seated while being easily transported up and down stairs.

Referring now to FIG. 3, the motorized stair chair is shown in an upright position. As shown in FIG. 3, the collapsible seating assembly 14 includes four support members 67, 68, 69, and 70 which together form a rectangular frame. The front support member 67 mounts pivotally to the front section 11. The four support members 67, 68, 69, and 70 together releasably support a polymer-based seat 21 (as shown in FIGS. 1 and 2). The seat 21 may be conveniently removed for cleaning. The collapsible seating assembly 14 may further include legs 71 and 72 that may be pivotally connected to the seat, and a leg cross member 33 connected to and extending between the legs 71 and 72. The foldable footrest 23 is pivotally mounted to the leg cross member 73. At the lower ends of the legs 71 and 72 are wheels 27. In one embodiment, wheels 27 are swivel casters such that the stair chair 10 may be conveniently moved about a surface. A lock release 74 is provided such that the front section 11 may be released from its extended position shown in FIG. 1, and situated in its collapsed position shown by FIG. 3.

The folded stair chair 10 has a small, compact size and shape. For example, the stair chair 10 can easily be stored in a closet, a vehicle, or underneath a bed without occupying a lot of space. The foldable motorized stair chair 10 has a thickness of about 24 centimeters, but can also be less than 24 centimeters with various components, such as the battery, removed from the chair 10.

The stair chair 10 may be provided with ground-contacting wheels 16. The ground-contacting wheels 16 are coupled to the chair frame 12. The ground-contacting wheels 16 may be disposed on the rear section 13 of the chair frame 12. In another embodiment, the stair chair 10 may include front bearings 27, either wheels or casters. In another embodiment, the ground-contacting wheels 16 may be removed and replaced by rails, skis, or other slidable, moveable mechanisms.

As shown in FIG. 2, the motorized stair chair 10 may also include a variety of support elements, such as a back 19, a seat 21, a foldable foot rest 23, a harness system 28 and a plurality of handles 25. These elements may include additional padding, ribbing, or other support structures/surfaces for the human subject. The back 19 and the seat 21 provide direct support for the human subject seated in the stair chair 10. The harness system 28 is used to stabilize and hold the human subject in the stair chair 10. The belt sections of the harness system 28 may be connected across the subject's chest, arms, lap, or legs.

The plurality of handles 25 are each accommodated slidably within a respective handle frame member 41, 43 (also shown in FIG. 2). The handle frame members 41, 43 are pivotally connected at one end to the chair frame 12, and pivotally connected at their front end by the front section 11 via respective brackets 45. By this arrangement, the frame members 152 and 154 may transition automatically from their position in FIG. 2, and rotated in parallel with the chair frame 12 for compact storage of the stair chair 10, as shown in FIG. 3.

The plurality of handles 25 may aid transportation of the stair chair 10 up or down stairs or to generally move the stair chair 10. The handles may be pivotable, telescoping, or combinations thereof. The handles may be located releasably in one of a variety of positions outward from the stair chair 10, providing the operator the best control and leverage when moving the stair chair along a set of stairs or other incline. The handles 25 and foot rest 23 may also be detachable to reduce the weight on the stair chair 10.

The motorized stair chair 10 may further include a motor 18, a removable battery 20, and a pair of motorized, continuous, rotatable tracks 22. The motor 18 is coupled to the chair frame 12. The motor 18 may be an energy-efficient motor and may also be removable. The removable battery 20 is configured to power the motor 18 and the stair chair 10. In another embodiment, the motor 18 may include a brake that is triggered when the power is turned off. Without being bound by theory, the brake (not shown) is designed to prevent the chair 10 from free-falling or free-wheeling down a flight of stairs if power is turned off. In one embodiment, the brake may be mounted on the motor 18, for example, the non-driven side. Alternatively, the brake may be mounted in a separate section of the housing 26. It is further contemplated that a brake may be attached adjacent the motorized tracks 22 or the gears 24.

The removable battery 20 and the motor 18 are separately coupled to the chair frame 12. In one embodiment, the removable battery 20 may be electrically connected to the motor 18. The battery 20 may be disposed horizontally on the rear section 13 of the chair frame 12. In another embodiment, the battery 20 may be disposed vertically on the rear section 13 of the chair frame 12. In yet another embodiment, the battery 20 may be attached to the chair frame 12 at a different location, which may include being attached to an operator of the stair chair or the human subject. For example, in one embodiment, the battery 20 may be separately carried by the operator to reduce weight on the stair chair 10. In yet another embodiment, the battery 20 may be attached to the motorized track assembly 15.

The motorized track assembly 15 includes a pair of motorized, continuous, rotatable tracks 22, each supported rotatably by rollers 61. The tracks 22 may comprise toothed belts for engaging stairs or other surfaces. The toothed belt may provide a gripping surface of the stair chair 10 in contact with the stairs to prevent slipping, and as an engagement member for an adjustable glide track resistance. The rollers 61 supporting the pair of tracks 22 are rotatably mounted a respective rail 63 and 65 at least at the ends thereof. In addition, the rollers 61 are arranged in a linear sequence or path on their respective rails 63 and 65 such that each respective track 22 rotates endlessly around a path defined by their respective rollers 61.

The motorized track assembly 15 further includes a rail cross member 77 mounted between the rails 63 and 65 at an upper portion thereof. At lower ends thereof, the rails 63 and 65 are pivotally mounted to the lower portion of the chair frame 12 to a respective support member 29. It is to be appreciated that the rails 63 and 65 are mounted in such a fashion that the rotatable tracks 22 do not engage the surface upon which the stair chair 10 is rolling about upon wheels 16, 27. The chair frame 12 also includes a pair of hand grips 76 that are releasably positionable in folded and unfolded positions, which may be conveniently used by the operator to maneuver the stair chair 10 around the surface.

The pair of motorized, continuous, rotatable tracks 22 are responsive to the motor 18. The tracks 22 are integrally and pivotally coupled to the rear section 13 of the chair frame 12. The tracks 22 are configured to engage stairs and drive the gears. In another embodiment, the tracks 22 may comprise flexible, durable material to engage stairs or other surfaces. Such materials may include polyurethane, polytetrafluoroethylene (PTFE), polypropylene, polyfluoroethylene, or any other seamless material that easily moves over a surface. The tracks 22 may rotate around a pair of pulleys as well as a drive gear operatively connected to a motor. The operator also has the ability to intervene at any time to slow, stop or reverse the direction of the pair of motorized tracks 22 by using control buttons.

Referring to FIG. 1, the pair of motorized tracks 22 may be released from their upright position with a track release mechanism. The track release mechanism 75 may be operatively connected to the plurality of the handles 25 or to the rear section 13 of the chair frame 12. In another embodiment, the track release mechanism 75 may fully detach the tracks from the chair in order to carry the chair separately than the tracks if doing so would be advantageous for the human subject and/or operator. The track release mechanism 75 deploys and retracts the tracks 22 by a series of linkages and a pivot point near the lower cross member 33.

The length and width of the tracks 22 allow the stair chair 10 to move over several stairs at a time. A plurality of gears 24 may be disposed between the motor 18 and the motorized tracks 22, where the motor 18 is configured to drive the motorized tracks 22 via the gears 24 disposed therebetween. The gears 24 are aligned with the motor 18 and the gearbox 35. For example, the motor 18 may be disposed in a horizontal position in relation to the gears 24. In another embodiment, the motor 18 and a gear box 35, which may contain drive gears, are disposed in a housing 26 coupled to the chair frame 12.

Referring to FIG. 4, a controller attached to the motorized stair chair is shown, according to an embodiment. In one embodiment, the motorized stair chair 10 may also include a controller 34 coupled to the chair frame 12. In another embodiment, the controller 34 may be contained within the housing 26. The controller 34 provides monitoring and control over the operation of the motorized tracks 22. In one embodiment, the controller 34 may be operable to pivot the pair of motorized tracks 22 from a raised position to a lowered position. In yet another embodiment, the controller 34 may be operable to pivot the pair of motorized tracks 22 in a forward direction or backward direction. In another embodiment, the controller 34 is configured to collapse or extend the collapsible seating assembly 14. In another embodiment, the chair 10 may have the ability to travel down stairs without operating the controller 34 to lower the motorized tracks 22. In this embodiment, the motor 18 generates a counter-electromotive force (counter-EMF). However, the motor 18 may be designed with appropriate materials having low electrical resistance to control the counter-EMF, e.g., metallic materials. Alternatively, the housing 26 may contain ferromagnetic material in order to appropriately control the counter-EMF.

The controller 34 may also monitor or control one or more other functions of the stair chair 10. For example, the controller 34 may provide information about the operational state of the battery 20 to an electronic display unit within the motorized stair chair 10 to convey information to the operator of the stair chair 10. The electronic display may further provide information regarding the human subject's body mass and any other pertinent information that would be important for the operator. The controller 34 may also provide information to buttons, switches, toggle units, a touch screen console, or combinations thereof. The controller 34 may also provide control over other systems of the motorized stair chair 10 such as the battery 20, the motor 18, or the electrical system of the chair 10. For example, the controller may automatically switch the chair into stand-by mode after one minute of inactivity.

The controller 34 may include any number of hardware and software components. For example, the controller 34 may include a microprocessor, an application-specific integrated circuit (ASIC), or a field programmable gate array (FPGA). The controller 34 may also include machine instructions stored within a memory device in the controller 34, which are capable of implementing one or more monitoring or control functions when executed by controller 34. For example, controller 34 may include one or more non-transitory memory devices such as a RAM, ROM, EPROM, EEPROM, flash memory, or any other memory capable of storing machine instructions for controller 34.

Referring to FIG. 5, a front view of the removable battery 20 mounted to the housing 26 is shown, according to an embodiment. The battery 20 may be mounted to the housing 26 via an attachment point 32 (best shown in FIGS. 8 and 9). The attachment point may be a movable attachment, for example, a pivoting, bending or folding attachment. The battery 20 may also be attached/detached to the stair chair 10 at another location with another structure. For example, the battery may also be attached underneath the seat or behind the seat. FIG. 8 shows the internal components of the attachment point for the battery, according to an embodiment.

Referring to FIG. 6, the internal components of the housing are shown, according to an embodiment. The internal components of the housing 26 may include a digital to analog converter 36, the controller 34, a motor 18, and a gear box 35. The external shell of the housing 26 may also include the power switch 38, a circuit breaker 30, and an attachment point 32 (as shown in FIG. 5). The battery 20 may be slidably attached to the housing 26 at the attachment point 32.

Referring to FIGS. 7, 8 and 9, the internal components of the battery 20 for attachment to the housing, the internal components of the attachment point for the battery; and the attachment point for the housing are shown, according to an embodiment. The battery 20 is slidably attached with mechanical latches to the attachment point 32. The mechanical latches prevent the battery 20 from detachment during operation of the stair chair 10. In other embodiments, the battery 20 may be attached to the attachment point 32 using a hinge, pivot, quick-release, bolt, rivet, screw, pin, velcro, or other securing mechanisms. Additionally, the battery's charger may be attached to the chair 10 or it may be separate from the chair in order to reduce the weight of the chair.

Although the operation of chair 10 is apparent from a review of the above discussion, that operation will now be summarized. This operation is specifically illustrated in FIGS. 1-4, and as shown therein, one of the advantages of the present application is that the stair chair can readily and easily be used to transport people both upstairs and downstairs in a controlled fashion using a controller to operate a pair of motorized tracks 22. The controller 34 may be operably attached to the chair 10 on the chair frame 12. The controller 34 may be physically wired to the chair or may operate the chair remotely and/or wirelessly. The controller 34 may rotate the motorized tracks forward or backward. In one embodiment, the controller 34 may also tilt the motorized tracks 22 in various positions. In another embodiment, the controller 34 may have a single button or a plurality of buttons that maneuver the tracks from a closed position to an open position, move the tracks around their respective gears, or detach the tracks from the chair. The controller may also include visual, audio, or sensory to indicate the position of the tracks 22.

In addition, as shown in FIG. 3, the stair chair 10 may be stored in its compact, collapsed position, and the chair may be fully opened, as shown in FIG. 1 by means of the track release mechanism 75. Furthermore, the weight of the chair can be significantly reduced by removing the battery 20. To open the chair, the collapsible seating assembly 14 is pulled into its open position and locked. When the collapsible seating assembly 14 is pulled into its opened position, the front section 11 and handle frame member 41 and 43 are automatically moved into their open or operating positions. The foot rest 23 may be extended to support the feet of a person thereon, if desired.

Once stair chair 10 is opened, a person may be seated in the chair. Then belt sections of the harness system 28 may be connected together across the chest, lap, and legs of that person. When the stair chair 10 is moved over a flat, or comparatively flat, surface, the stair chair is supported by wheels 16, 27, and may be controlled by extending the handgrips 76, and/or via the handlebar 37. When the stair chair 10 is transitioning along stairs, the stair chair is supported by the motorized track assembly 15, which engages and extends across the top edges of the stairs.

The extendable handles 25 may be locked in an extended position to provide better leverage and control. The stair chair 10 may be transitioned along stairs in a controlled fashion, with the controller providing control over the components of the stair chair 10.

While the present disclosure has been particularly shown and described with reference to specific embodiments, it should be understood by those skilled in the art that various changes in form and detail may be made therein without departing from the spirit and scope of the disclosure as defined by the appended claims.

1. A motorized stair chair for transporting a human subject, the chair comprising:
a chair frame comprising front and rear sections;
a collapsible seating assembly attached to the front section of the chair frame;
ground-contacting wheels coupled to the chair frame;
a motor coupled to the chair frame;
a removable battery configured to power the motor and the motorized stair chair, wherein the battery and the motor are separately coupled at different locations on the chair frame; and
a pair of motorized continuous, rotatable tracks responsive to the motor, the tracks being integrally and pivotally coupled to the rear section of the chair frame, wherein the motorized tracks are configured to engage stairs.

2. The motorized stair chair of claim 1, further comprising a plurality of gears disposed between the motor and the motorized tracks, wherein the motor is configured to drive the motorized tracks via the gears disposed therebetween.

3. The motorized stair chair of claim 2, wherein the motor and a gear box are disposed in a housing coupled to the chair frame.

4. The motorized stair chair of claim 1, wherein the battery is disposed horizontally on the rear section of the chair frame.

5. The motorized stair chair of claim 1, wherein the battery is disposed vertically on the rear section of the chair frame.

6. The motorized stair chair of claim 1 further comprising a controller coupled to the chair frame.

7. The motorized stair chair of claim 6, wherein the controller is operable to pivot the pair of motorized tracks from a raised position to a lowered position.

8. The motorized stair chair of claim 6, wherein the controller is operable to drive the pair of motorized tracks in a forward direction or a backward direction.

9. The motorized stair chair of claim 6, wherein the controller is configured to collapse or extend the collapsible seating assembly.

10. The motorized stair chair of claim 6, wherein the controller includes a microprocessor.

11. The motorized stair chair of claim 6, wherein the controller provides information to an electronic display.

12. The motorized stair chair of claim 11, wherein the electronic display is configured to provide information about the operational state of the battery.

13. The motorized stair chair of claim 11, wherein the electronic display comprises buttons, switches, toggle switches, a touch screen console, or combinations thereof.

14. The motorized stair chair of claim 1, further comprising a plurality of handles coupled to the chair frame, wherein the handles are pivotable, telescoping or combinations thereof.

15. The motorized stair chair of claim 1, wherein the pair of motorized tracks comprise toothed belts for engaging stairs.

16. The motorized stair chair of claim 1, further comprising a track release mechanism configured to release the pair of motorized tracks from an upright position.

17. The motorized stair chair of claim 1, wherein the chair frame includes left and right support members, a cross member supported by and positioned between the left and right support members, a pair of hand grips releasably positionable in folded and unfolded positions, and an height adjustable handle bar slidably accommodated in respective cavities of said left and right support members.

18. The motorized stair chair of claim 1, wherein the collapsible seating assembly includes a seat and a pair of legs pivotally connected to the seat.

19. The motorized stair chair of claim 1, wherein the pair of motorized tracks comprise a motorized track assembly.

20. The motorized stair chair of claim 1, wherein the pair of motorized tracks comprise a latching assembly.
